(19) United States
(12) Patent Application Publication
(10) Pub. No.: US 2022/0092508 A1
(43) Pub. Date: Mar. 24, 2022

(54) METHOD AND SYSTEM FOR GENERATING CONTEXTUAL NARRATIVE FOR DERIVING INSIGHTS FROM VISUALIZATIONS

(71) Applicant: Larsen & Toubro Infotech Ltd, Mumbai (IN)

(72) Inventors: Deepthi Suthan, Thrissur (IN); Pradeepta Mishra, Bangalore (IN)

(73) Assignee: Larsen & Toubro Infotech Ltd, Mumbai (IN)

(21) Appl. No.: 17/205,942

(22) Filed: Mar. 18, 2021

(30) Foreign Application Priority Data
Sep. 21, 2020 (IN) 202021040776

(51) Int. Cl. G06Q 10/06; G06F 16/26

(52) U.S. Cl. CPC G06Q 10/06393; G06F 16/26

(57) ABSTRACT

The present disclosure discloses a system and method comprising a Natural Language Generation (NLG) module in a data visualization environment for generating a contextual narrative for visualization e.g. graphs in natural language. The narrative is generated using a composite system comprising business input, ontology structure comprising semantical relationship and a deep learning paraphrase model to express and enable semantics in a personalized manner. The essential element of the disclosure is the system and method for providing context to generated narrative, using ontology structure comprising semantic relationships and search criteria including, but not limited to, filters and types of aggregations.

### TECHNICAL FIELD OF THE DISCLOSURE

The present disclosure relates generally to data analytics, and more particularly, but not exclusively to a method and a system for generation of context aware insights using semantic web, deep learning model and domain specific knowledge base for a business user to derive insights from visualizations such as graphs.

### BACKGROUND

Traditionally, organizations employ several Business Intelligence (BI) computer software solutions and data visualization tools to extract insights for critical operations by utilizing the various features of analytics and reporting functionalities integrated within such BI software solutions. There exists several kinds of BI computer software solutions comprising a variety of dashboards with different types of visualizations that may display a plethora of parameters related to an organization such as the status of business analytics metrics, key performance indicators (KPIs) and important data points for an organization, department, team or process on a single screen.

However, visualizations displayed through BI software solutions are complex and at many instances difficult to interpret. The interpretation is a manual process which may create a scope for mistakes in analyzing the analyzed data. Moreover, interpretation of such visualizations may only be possible by professionals having subject matter expertise such as data analysts, business analysts, data scientists, etc. This results in a lot of time being spent by the decision makers of the organizations to interpret data rather than focusing upon the planning strategies to improve operation, sales of a team or an organization.

Essentially, it is important to select the most appropriate visualization method for a given data set with the right context. Often the business analysts have to work with data that come from unknown domains wherein the lack of domain knowledge is a prime reason for incorporating either inappropriate or non-optimal visualization techniques. Domain experts can easily recommend commonly used best visualization types for a given data set in that domain. However, availability of a domain expert in every data analysis project cannot be guaranteed.

Currently, several techniques exist to solve the afore-mentioned problem of complex visualizations and its interpretations along with generating context aware insights by automatically generating summary of the visualizations using machine learning and deep learning techniques. Systems and applications that act on or change their behavior based on perceived context aspects are context-aware. Thus, these systems are aware of their environment and can automatically react to changes. Such context aware systems are built utilizing rule-based, statistical and template-based methods of machine learning techniques. For example, the rule-based system utilizes domain dependent rules to manipulate different stores of data to generate a “natural” sounding text. Moreover, the statistical Natural Language Generation (NLG) system bypasses extensive rule construction by using corpus data to “learn” the set of rules and creates alternative generations of natural language text from the statistical rules and then chooses the best alternative at a given point in a generated discourse which is governed by a decision model. On the other hand, the template-based NLG system creates a template where empty slots are replaced by specific information.

U.S. Ser. No. 10/366,167 (US'167) discloses a system and a method for generating a contextual summary of one or more charts. The system comprises a summary generating system capable of extracting chart data associated with each chart received from one or more sources and determining context of the chart data. The summary generating system computes statistical data of each chart by analyzing chart data based on predefined rules corresponding to the context. The form of analysis to be performed depends on the context of the chart data. Furthermore, insights of each chart are generated by mapping the statistical data with predefined narratives corresponding to the context. The summary generating system, automatically generates the contextual summary of the charts corresponding to the context of the chart data in a predefined template format using the generated insights of each of the one or more charts. The contextual summary provides holistic information of the interpreted charts. However, US'167 fails to disclose a concept of deep learning paraphrase model for generating summary of the charts.

U.S. Pat. No. 9,529,795 (US'795) discloses a method of receiving a corpus comprising a set of pre-segmented texts. The method further includes creating a plurality of modified pre-segmented texts for the set of pre-segmented texts by extracting a set of semantic terms for each pre-segmented text within the set of pre-segmented texts and applying at least one domain tag for each pre-segmented text within the set of pre-segmented texts. The method further includes clustering the plurality of modified pre-segmented texts into one or more conceptual units, wherein each of the one or more conceptual units is associated with one or more templates, wherein each of the one or more templates corresponds to one of the pluralities of modified pre-segmented texts. However, US'795 fails to mention the concept of parsing graph data.

U.S. Pat. No. 9,405,448 (US'448) provides a method and a system for generating and annotating a graph. The method discloses a concept of determining one or more key patterns in a primary data channel, wherein the primary data channel is derived from raw input data in response to a constraint being satisfied. A method may further include determining one or more significant patterns in one or more related data channels. A method may further include generating a natural language annotation for at least one of the one or more key patterns or the one or more significant patterns. A method may further include generating a graph that is configured to be displayed in a user interface, the graph having at least a portion of the one or more key patterns, the one or more significant patterns and the natural language annotation. However, US'167 fails to disclose a concept of deep learning paraphrase model for generating summary of the charts.

U.S. Pat. No. 9,396,181 (US'181) discloses a method and a system for natural language generation and data analysis system. The user context is analyzed from user question and converted into SQL query to pull required data subset from data repository. US'181 discloses a concept of analyzing the data and generating natural language sentences/phrases. Moreover, US'181 discloses a concept of ontology comprising object concepts and relationship. However, the ontology concept disclosed in US'181 is different from as disclosed in the present invention.

However, the above mentioned state-of-the-art techniques and methods fail to generate context aware insights using semantic web, deep learning model and domain specific knowledge base for the business user to derive actionable insights from visualizations which may result in generating inaccurate or inefficient insights due to the number of complexities involved in the utilized machine learning techniques.

Thus, there arises a need for an automated and simpler method and system for automatically analyzing the data behind visualizations, interpret the data and graphs using business inputs, ontology structure comprising semantic relationships and deep learning paraphrasing model that may comprise several domain-based actions to help generate narratives that precisely answers business user question, attempts to answer any follow-up questions. This will enable the data scientists to make visualization decisions with limited domain knowledge.

### SUMMARY

One or more shortcomings of prior art are overcome, and additional advantages are provided through present disclosure. Additional features are realized through techniques of the present disclosure. Other embodiments and aspects of the disclosure are described in detail herein and are considered a part of the present disclosure.

In one aspect of the disclosure, a method for generating a contextual narrative of one or more visualizations is disclosed. The method includes providing an input feed to a processor; processing the input feed based on a set of predefined business rules, wherein the method of generating the contextual narrative further comprises, generating a narrative of a visualization based on the processed input feed, wherein a context is provided to the generated narrative based on a plurality of semantic relationships established in an ontology file obtained from the input feed and at least one search criterion including, but not limited to, one or more filters and one or more aggregation types.

In another aspect of the disclosure, a system for generating a contextual narrative of one or more visualizations is disclosed. The system includes a data input module, wherein the data input module provides an input feed; a processor for processing the input feed based on a set of predefined business rules; and wherein the system for generating the contextual narrative further comprises, a narrative generator module for generating a narrative of a visualization based on the processed input feed, wherein a context is provided to the generated narrative based on a plurality of semantic relationships established in an ontology file obtained from the input feed and at least one search criteria including, but not limited to, one or more filters and one or more aggregation types.

Foregoing summary is illustrative only and is not intended to be in any way limiting. In addition to illustrative aspects, embodiments, and features described above, further aspects, embodiments, and features will become apparent by reference to drawings and following detailed description.

### BRIEF DESCRIPTION OF DRAWINGS

FIG. 1 is a block diagram describing overall structure of various NLG modules.

FIG. 1(a) is a block diagram providing overview of NLG API architecture diagram.

FIG. 2 is a diagram representing a flowchart for contextual narrative generation for visualization as per the present disclosure.

FIG. 3 is an exemplary snapshot of contextual narrative provided to a user basis user query and visualization.

FIG. 4 is a block diagram describing insight resolution module.

FIG. 5 is a block diagram describing language generation module.

FIG. 6 is a block diagram describing mathematical and statistical analytics module.

### DETAILED DESCRIPTION OF THE DISCLOSURE

In following detailed description of embodiments of present disclosure, numerous specific details are set forth in order to provide a thorough understanding of the embodiments of the disclosure. However, it will be obvious to one skilled in art that the embodiments of the disclosure may be practiced without these specific details. In other instances, well known methods, procedures, components, and circuits have not been described in detail so as not to unnecessarily obscure aspects of the embodiments of the disclosure.

References in the present disclosure to “one embodiment” or “an embodiment” mean that a feature, structure, characteristic, or function described in connection with the embodiment is included in at least one embodiment of the disclosure. Appearances of phrase “in one embodiment” in various places in the present disclosure are not necessarily all referring to same embodiment.

In the present disclosure, word “exemplary” is used herein to mean “serving as an example, instance, or illustration.” Any embodiment or implementation of present subject matter described herein as “exemplary” is not necessarily to be construed as preferred or advantageous over other embodiments.

The present disclosure may take form of a hardware embodiment, a software embodiment, or an embodiment combining software and hardware aspects that may all generally be referred to herein as a ‘system’ or a ‘module’. Further, the present disclosure may take form of a computer program product embodied in a storage device having computer readable program code embodied in a medium.

While the disclosure is susceptible to various modifications and alternative forms, specific embodiment thereof has been shown by way of example in drawings and will be described in detail below. It should be understood, however that it is not intended to limit the disclosure to the forms disclosed, but on contrary, the disclosure is to cover all modifications, equivalents, and alternative falling within scope of the disclosure.

Terms such as “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude existence of other elements or additional elements in the system or apparatus.

In following detailed description of the embodiments of the disclosure, reference is made to drawings that form a part hereof, and in which are shown by way of illustration specific embodiments in which the disclosure may be practiced. These embodiments are described in enough detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure discloses a system and method comprising a Natural Language Generation (NLG) module in a data visualization environment for generating a contextual narrative for visualization e.g. graphs in natural language. The narrative is generated using a composite system comprising business input, ontology structure comprising semantical relationship and a deep learning paraphrase model to express and enable semantics in a personalized manner. The essential element of the disclosure is the system and method for providing context to generated narrative, using ontology structure comprising semantic relationships and search criteria including, but not limited to, filters and types of aggregations.

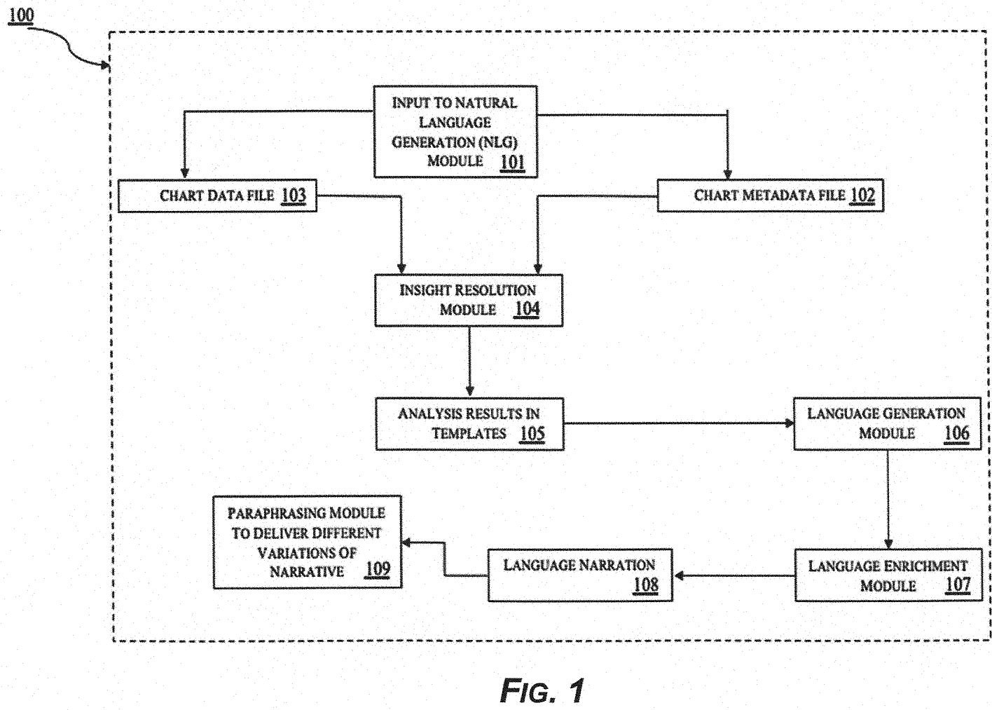

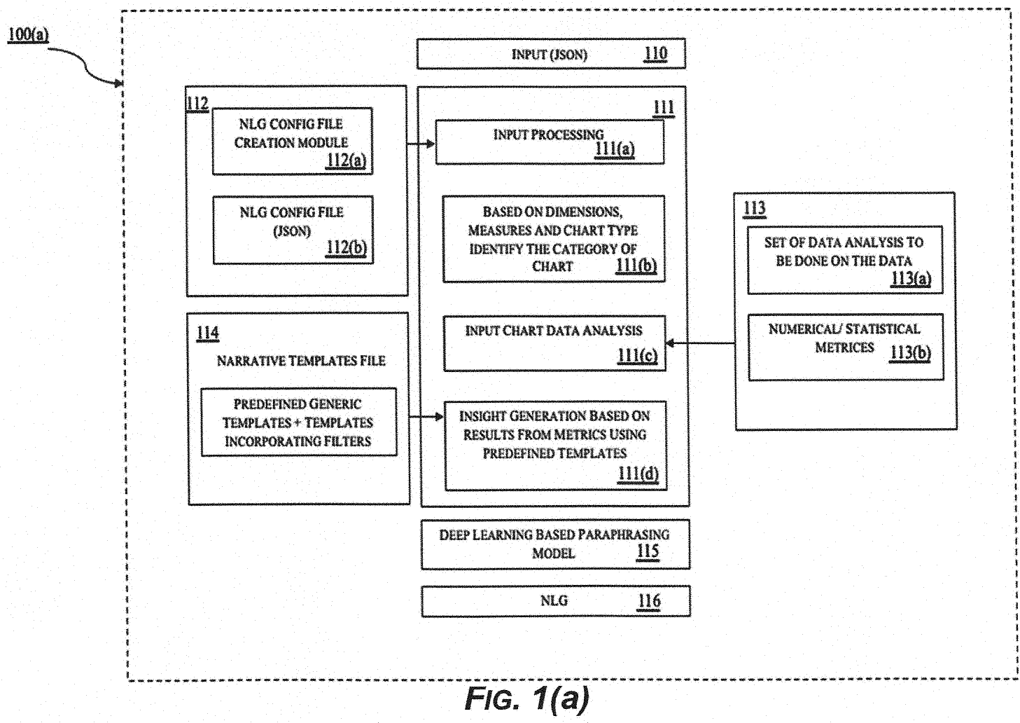

FIG. 1 describes the overall structure and modules present within NLG module 100. An input feed 101 is provided to the NLG module 100, wherein the input feed 101 comprises a visualization file and computational file, wherein the visualization file includes chart data file 103 and chart meta-data file 102 i.e. a set of data required to prepare one or more visuals for one or more questions provided by one or more users and computational file includes the set of data required to compute one or more additional estimated values and one or more business metric models for computing required business metrics such as growth rate, etc. as per plurality of questions provided by the one or more users. The chart data file 103 and the chart metadata file 102 is provided to an insight resolution module 104. The analysis results along with template 105 is provided to a language generation module 106. The language generated by the language generation module 106 is fed into a language enrichment module 107 and finally a narration 108 is obtained, which is subsequently provided to a paraphrasing module 109 to deliver different variations of narratives.

FIG. 1(a) provides an overview regarding NLG API architecture 100(a) wherein an input JSON file 110 (a data file comprising data in standard JSON file structure) is provided for processing 111(a). The input JSON file 110 is processed to identify category of chart based on a plurality of dimensions, measures and chart type 111(b). Further, input chart data analysis 111(c) is conducted using mathematical and statistical metrics 113 (b) such as for e.g. regression, range, skew, etc. and other set of data analysis to be done on the data 113(a) such as for e.g. cleaning etc. Insights are generated on the basis of results obtained from mathematical and statistical metrics using predefined templates 111(d), wherein the predefined templates 111(d) are provided by narrative template file 114 comprising predefined a) generic templates and b) templates incorporating filters. The input JSON file 110 is processed using NLG config file 112(b) generated by NLG config file creation module 112(a), wherein the NLG config file module 112 (b) comprises predefined business rules regarding data analysis and its type. Further, insights generated at step 111(d) is fed into deep learning paraphrasing model 115, thereby generating natural language insights 116.

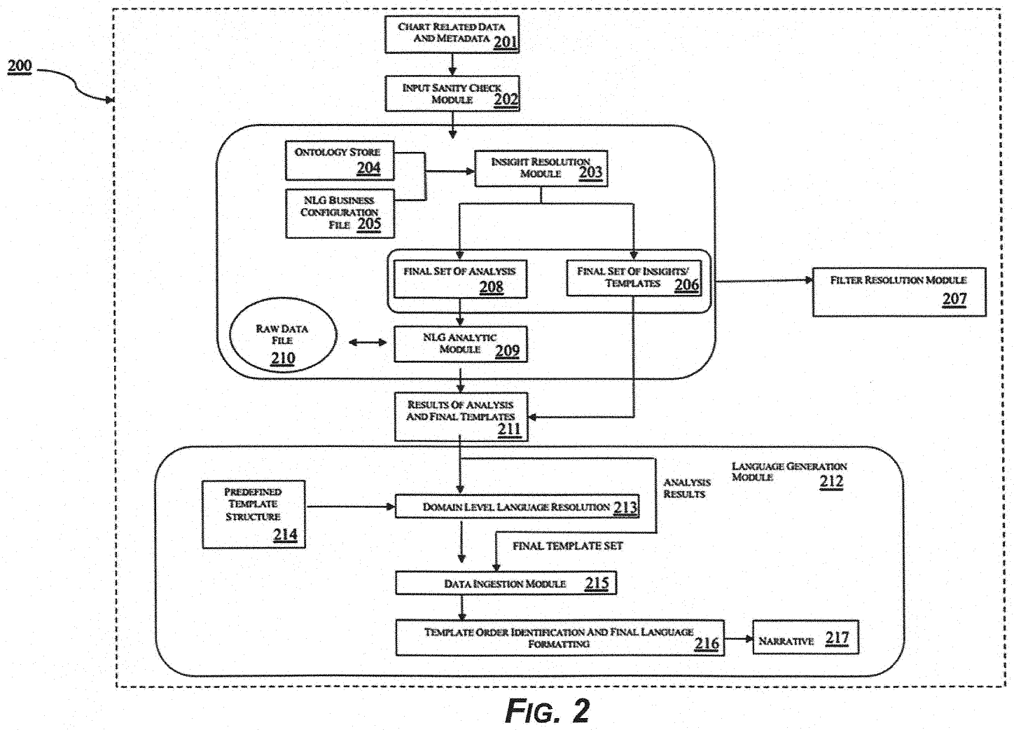

FIG. 2 provides a detailed flowchart 200 comprising steps for generating contextual narrative for visualization such as graphs. To this end, the input data comprising chart data 103 and chart meta-data 102 is passed through a data sanity check module 202. Further, the data sanity check module 202 checks for inconsistencies in the input data and ensures that the input is in the specific format e.g. time entities must be present in any of the allowed date-time format. Further, the data is fed into an insight resolution module 203. In embodiments thereof, the insight resolution process performs comparison of ontology store 204 created during initial setup against natural language generation business configuration file 205 or predefined business rules 205. The entities in the ontology store 204 is set against the entities in the knowledge graph. Further, actions and additional semantic relationships are triggered based on their presence in the input. The resolution process is triggered and conducts analysis by considering following parameters:
Domain
Chart Type
Actions
Semantic relations between measures and dimensions
Filters applied in the Chart

Further, the output of the insight resolution module 203 is fed into a filter resolution module 207, wherein a filter resolution module 207 produces final set of analysis, and as illustrated at 208 the filter resolution module 207 produces final set of insights/templates 206. These final set of analysis and insights/templates 206 are passed to NLG analytic module 209 for computation, wherein the computation utilizes computation data file present within raw data file 210. The final results of analysis and final templates 211 are fed into the language generation module 212 for narrative 217 generation. The language generation module 212 comprises domain level language resolution 213, data ingestion module 215 and template order identification and language formatting 216. The predefined template structure 214 is utilized by domain level language resolution 213 for analysis.

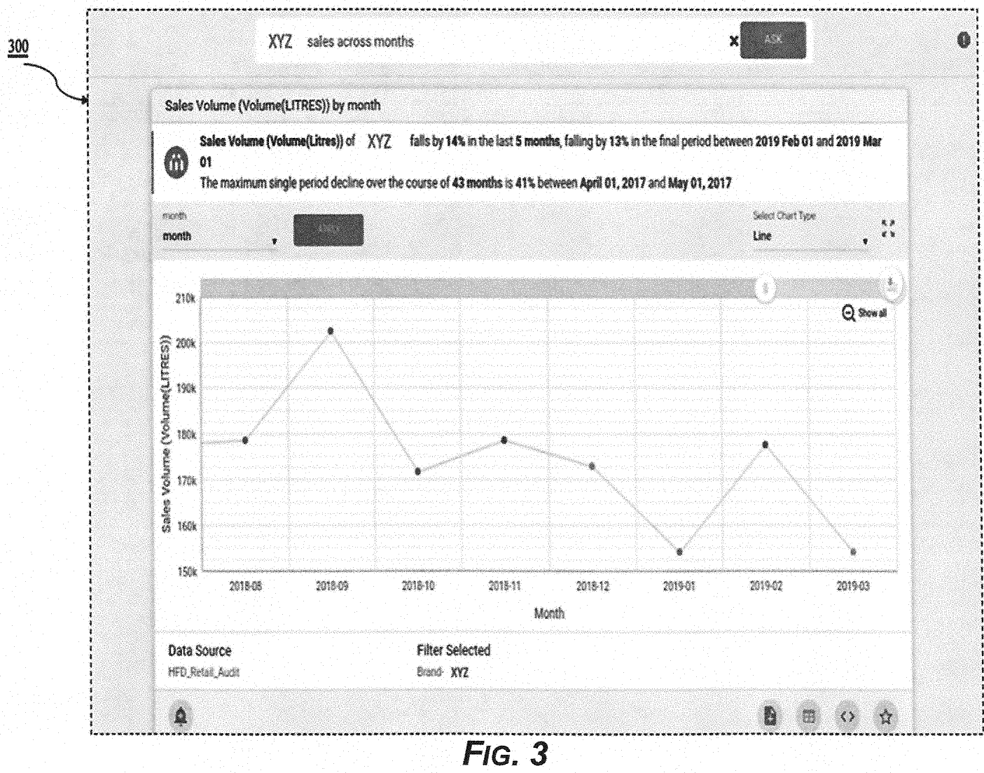

In one exemplary embodiment FIG. 3, a snapshot of contextual narrative provided to a user basis user query and visualization 300 is illustrated wherein the chart plots “Horlicks sales across months”, the input to NLG module 100 will comprise the measure being plotted i.e. ‘Sales’ and the dimension i.e. ‘XYZ’. The additional chart metadata will provide detail regarding domain of the chart i.e. retail, category of measure i.e. sales numbers are from money category, unit of measures i.e. unit associated with sales is dollars and filter enabled in the time category to limit the visualization i.e. across months. The narrative generated by the system in this case is ‘Sales Volume (Volume (Liters)) of XYZ falls by 14% in last 5 months, falling by 13% in the final period between 2019 Feb. 1 and 2019 Mar. 1. The maximum single period decline over the course of 43 months is 41% between Apr. 1, 2017 and May 1, 2017’

Further, the ontology store 204 depicting the semantic relationships between the attributes in the study will have details regarding these measures and dimensions. Also, it may comprise formatting details like how the sales numbers should look like in the narrative, or alternate usages that should appear instead of the chart labels appearing in the narrative.

In embodiments, the natural language generation business configuration file will include the various sets of analysis that may be triggered for a chart plotting a measure across a categorical dimension. Further, in order to fine tune this set of analysis further, the insight resolution module considers the domain of the data and the semantic relationships associated with the measures and dimensions. Moreover, the knowledge graph can semantically differentiate between measures like “Sales”, “Profit” and categorical dimensions like “Brands”, “Countries”. One of such examples is key player analysis.

The filter resolution module 207 can further trigger benchmark analysis on previous year data. These final set of analysis end in a final set of insights/templates.

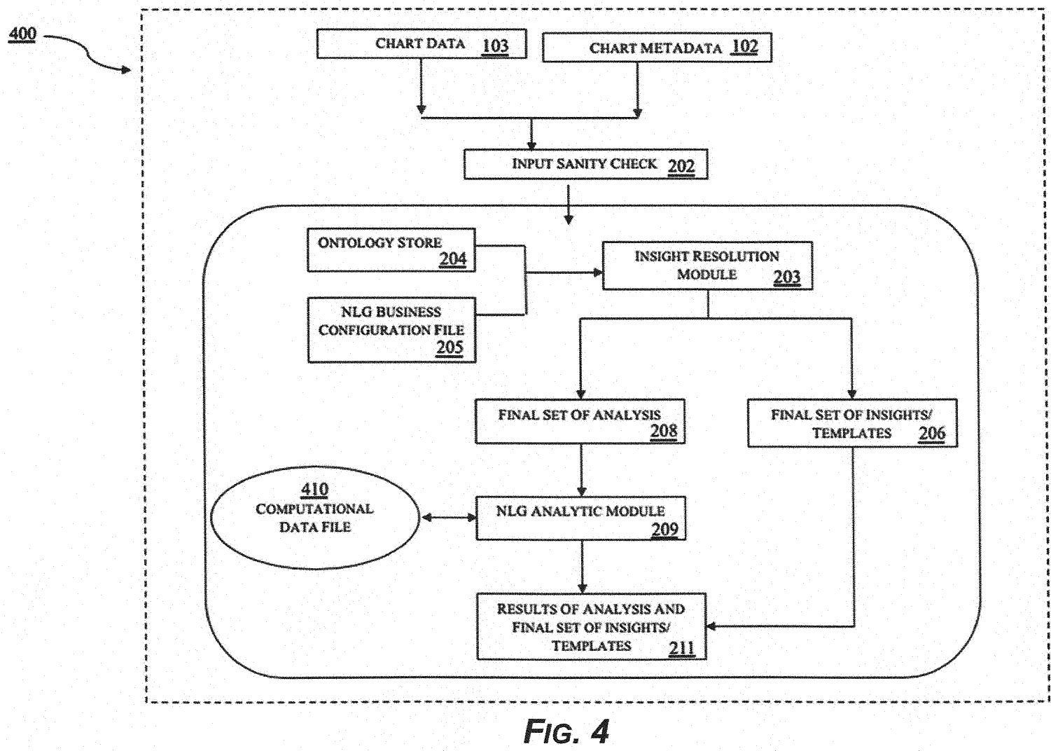

FIG. 4 describes a block diagram describing insight resolution module 400 in detail. The insight resolution module 203 receives chart data 103 and chart meta-data 102 before an initial sanity check 202. Once the sanity check is complete, the chart data and chart meta-data is fed into the insight resolution module 203. The insight resolution module 203 performs analysis using ontology store 204 and NLG business configuration file 205 to provide final set of analysis 208 and final set of insights/templates 206. Further, mathematical and statistical analysis is performed by NLG analytic module 209 on the data present in the computational data file 408. Finally, the result of mathematical and statistical analysis and final set of insights/templates 206 are combined to derive results of analysis and final set of insights/templates 211.

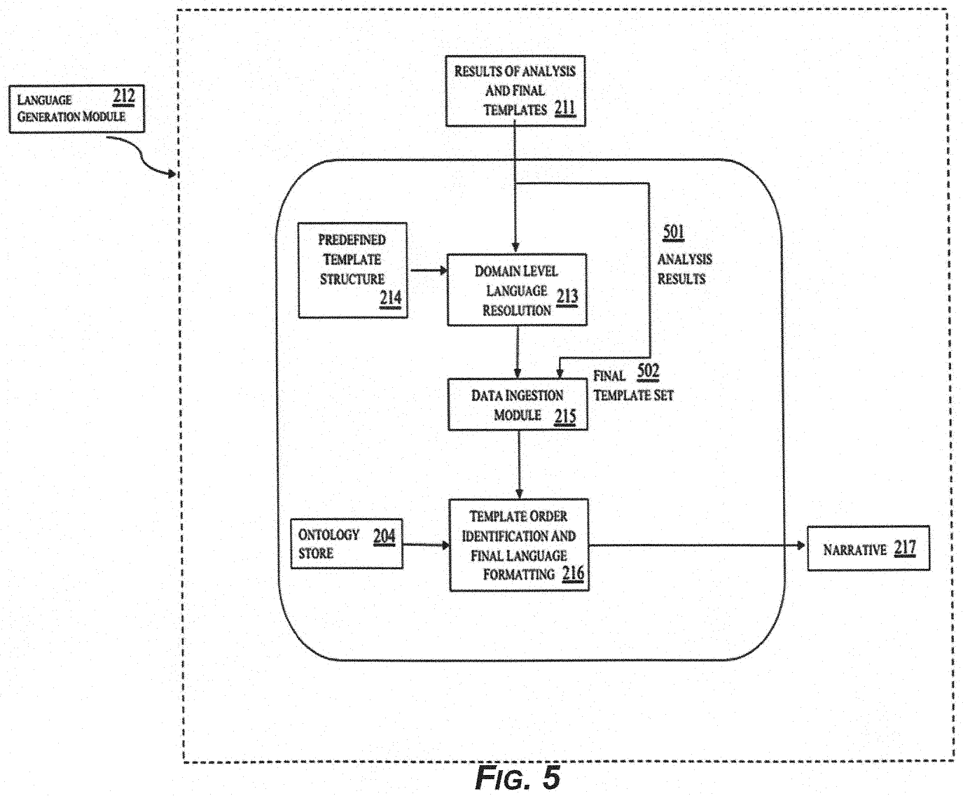

FIG. 5 describes in detail the language generation module 212. The output of the insight resolution module 203 is fed into the language generation module 212. The language generation module 212 comprises a data ingestion module 215 and various steps such as domain level language resolution 213, template order identification and final language formatting 216. The analysis results 501 and final template set 502 are fed into the data ingestion module 215. The output of the data ingestion module 215 is provided and analyzed in template order identification and final language formatting module 216 for narrative 217 generation. The predefined template structure 214 is fed into domain level language resolution 213 and ontology store 204 is fed into template order identification and final language formatting module 216 for analysis.

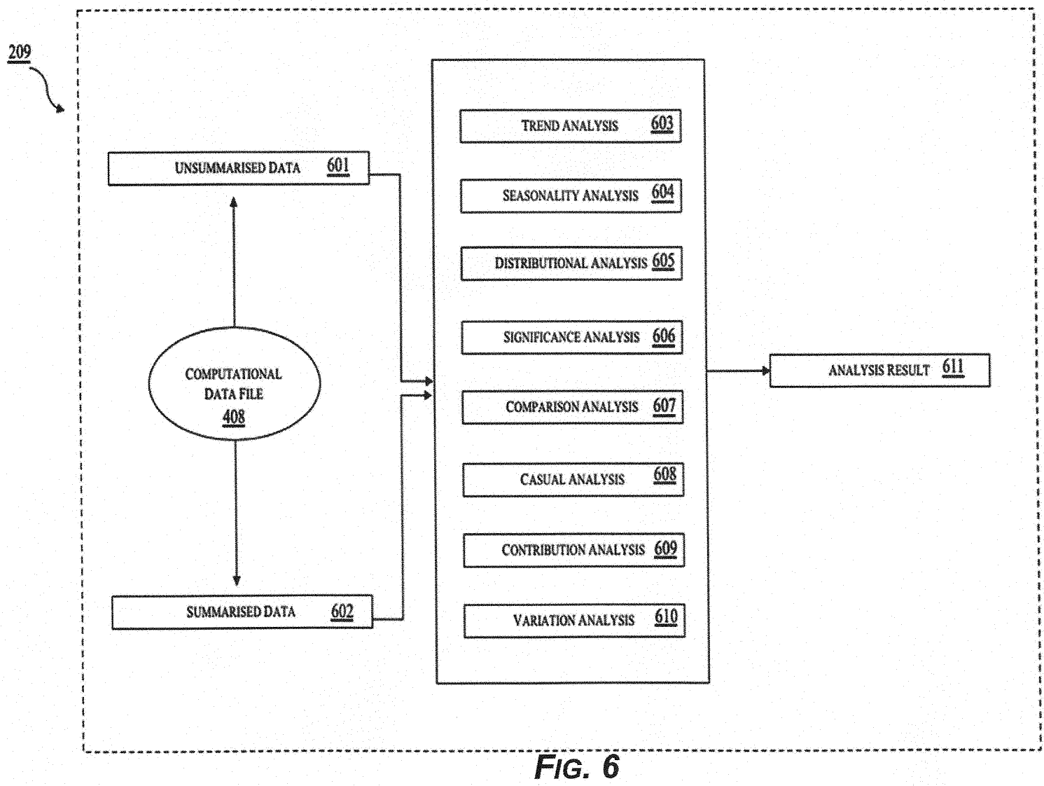

FIG. 6 provides in-depth view of NLG analytic module 209 conducting mathematical and statistical analysis. The analytics module comprises various models to conduct mathematical and statistical analysis such as trend analysis 603, seasonality analysis 604, distributional analysis 605, significance analysis 606, comparison analysis 607, casual analysis 608, contribution analysis 609, variation analysis 610 etc. The analysis is conducted using computational data file 408, wherein the computational file 408 comprises summarized data 602 and unsummarized data 601 to generate final analysis result 611.

Another embodiment of the present invention discloses a language enrichment module. The said generated narrative is fed into various models such as plural/singular check, lexical entailment, activity, symmetry, predicate argument structure, alterations, ellipsis, quantification, grammar check, propositional structure, etc.

Another embodiment of the present invention discloses a paraphrasing module. The final narration 217 post being fed and refined by various models of language enrichment module, is fed sequentially into neural network model (sequence to sequence builder (LSTM-CNN), generator module training, evaluator module for identification and finally paraphrase generation module. The paraphrasing module comprises set of neural networks trained with corpus of training data related to natural language generation templates.

Below given exemplary embodiment provides detailed explanation for different parts of generating contextual narrative.

Part 1 is input data feed (JSON structure):
The input data feed comprises labels (X axis and Y axis) of measures and dimensions plotted in the chart, data points and additional metadata, wherein the additional metadata may include,
The types of labels—(money, population etc.) categorized based on the domains in the NLG business configuration file
The unit associated with the data
Filters applied on the Chart—the filters can be geographical, time, or other categories
The intent behind the chart—key player analysis, forecast analysis etc.

Part 2 is initial set-up of natural language generation module:
The NLG module is configured differently for each new use case, wherein during the initial set-up process, features are enabled relating to the domain of the data, and user is provided opportunity to design special features based on the domain
In cases where this initial set-up process is not feasible, the NLG module triggers a default set of analysis/insights for the charts
Further, as part of initial set-up process, an ontology structure corresponding to the studies being plotted is created and the actual raw data of the studies is made available to the NLG analytic module

Part 3 is setting up of ontology structure:
Ontology structure comprises information related to the studies being plotted during data visualization and formatting information related to the attributes in the charts and rules for their realizations in the narrative
Ontology structure replicates the categories of attributes and relationships stored in the NLG business configuration file

Part 4 is feeding of raw data:
The actual raw data file of the studies is made available to the NLG module, upon which analyzes (benchmark analysis, competitor analysis etc.) is performed during insight generation process.

Another embodiment of the present disclosure describes the process of automatically generating natural language from non-linguistic input which comprises three steps namely, content determination, sentence planning and surface planning. The workflow for natural language generation for visualization environment is as follows:
Input feed: The chart output data along with chart metadata is collected and provided to the NLG module for further processing
Analysis: The data provided to the NLG module is analyzed by the basis NLG business configuration file and generates first level of narrative
NLG: This part of the workflow provides NLG filters for generating various output contextual narratives.

The NLG business configuration file comprises keyword-based knowledge graph (ontology structure) containing knowledge on various domains like Finance, Pharma etc., and entities stored in the knowledge graph can be domains, domain-specific attributes, set of possible relationships between attributes, set of possible insights, set of possible analysis, set of possible actions.

Insight resolution generates a fixed set of insights considering rules based on categories of entities and their relationship to arrive at the final set of insights.

Predefined set of templates is a file storage comprising large set of templates in natural language, categorized based on insight type and further divided into template formations containing enhanced language features based on domain. The default set of templates and other template groups with domain-based distinctions has hierarchical relationship between them, wherein this relationship is utilized by the NLG module to arrive at the final set of triggered insights. The actual natural language realization of complete insight set is stored in these template files. Further, this file contains the following additional details related to each template:
properties tagging the insight type of a template
properties for resolving the final order of the templates
properties for resolving the numbers (number type, precision, unit etc.) that are part of the template
a flag which can be used to block/trigger a template during the initial NLG module set up for a client.

Another embodiment of the present disclosure explains in detail the entire process of natural language generation being performed in the past and integration of the present disclosure to improve user experience by providing contextual narratives for visualizations. The contextual narratives are generated by using semantic web, deep learning model and domain specific knowledge base for the business user to derive insights from visualizations.

In an embodiment, the computer system may be a communication unit, which is used for pushing the plurality of messages from the first node to the second node. The computer system may include a central processing unit (“CPU” or “processor”). The processor may comprise at least one data processor for executing program components for executing user or system-generated business processes. The processor may include specialized processing units such as integrated system (bus) controllers, memory management control units, floating point units, graphics processing units, digital signal processing units, etc.

The processor may be disposed in communication with one or more input/output (I/O) devices via I/O interface. The I/O interface may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface, the computer system may communicate with one or more I/O devices. In some implementations, the processor may be disposed in communication with a communication network via a network interface. The network interface may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface and the communication network, the computer system may be connected to the sender server and the recipient server.

The communication network can be implemented as one of the several types of networks, such as intranet or any such wireless network interfaces. The communication network may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 508 may include a variety of network devices, including routers, bridges, servers, computing devices, storage devices, etc.

In some embodiments, the processor may be disposed in communication with a memory e.g., RAM, and ROM, etc., via a storage interface. The storage interface may connect to memory including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory may store a collection of program or database components, including, without limitation, user/application, an operating system, a web browser, a mail client, a mail server, a user interface, and the like. In some embodiments, computer system may store user/application data, such as the data, variables, records, etc. as described in this invention. Such databases may be implemented as fault-tolerant, relational, scalable, secure databases such as Oracle or Sybase.

The operating system may facilitate resource management and operation of the computer system. Examples of operating systems include, without limitation, Apple Macintosh™ OS X™, UNIX™, Unix-like system distributions (e.g., Berkeley Software Distribution (BSD), FreeBSD™, Net BSD™, Open BSD™, etc.), Linux distributions (e.g., Red Hat™, Ubuntu™, K-Ubuntu™, etc.), International Business Machines (IBM™) OS/2™, Microsoft Windows™ (XP™, Vista/7/8, etc.), Apple iOS™, Google Android™, Blackberry™ Operating System (OS), or the like. A user interface may facilitate display, execution, interaction, manipulation, or operation of program components through textual or graphical facilities. For example, user interfaces may provide computer interaction interface elements on a display system operatively connected to the computer system, such as cursors, icons, check boxes, menus, windows, widgets, etc. Graphical User Interfaces (GUIs) may be employed, including, without limitation, Apple™ Macintosh™ operating systems' Aqua™, IBM™ OS/2™, Microsoft™ Windows™ (e.g., Aero, Metro, etc.), Unix X-Windows™, web interface libraries (e.g., ActiveX, Java, JavaScript, AJAX, HTML, Adobe Flash, etc.), or the like.

The present computer implemented system includes a system, a network, a plurality of user devices, a database, a memory, a processor, I/O interfaces, a plurality of modules, and plurality of data.

The network interconnects the user devices and the database with the system. The network includes wired and wireless networks. Examples of the wired networks include a Wide Area Network (WAN) or a Local Area Network (LAN), a client-server network, a peer-to-peer network, and so forth. Examples of the wireless networks include Wi-Fi, a Global System for Mobile communications (GSM) network, and a General Packet Radio Service (GPRS) network, an enhanced data GSM environment (EDGE) network, 802.5 communication networks, Code Division Multiple Access (CDMA) networks, or Bluetooth networks.

In the present implementation, the database may be implemented as enterprise database, remote database, local database, and the like. The database may be located within the vicinity of the system or may be located at different geographic locations as compared to that of the system. Further, the database may themselves be located either within the vicinity of each other or may be located at different geographic locations. Furthermore, the database may be implemented inside the system and the database may be implemented as a single database or as multiple databases.

In the present implementation, the system includes one or more processors. The processor may be implemented as one or more microprocessors, microcomputers, microcontrollers, digital signal processors, central processing units, state machines, logic circuitries, and/or any devices that manipulate signals based on operational instructions. Among other capabilities, the at least one processor is configured to fetch and execute computer-readable instructions stored in the memory.

The memory may be coupled to the processor. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

Further, the system includes modules. The modules include routines, programs, objects, components, data structures, etc., which perform particular tasks or implement particular abstract data types. In one implementation, the module includes an input module, an estimation module, a display module and other modules. The other modules may include programs or coded instructions that supplement applications and functions of the system.

As described above, the modules, amongst other things, include routines, programs, objects, components, and data structures, which perform particular tasks or implement particular abstract data types. The modules may also be implemented as, signal processor(s), state machine(s), logic circuitries, and/or any other device or component that manipulate signals based on operational instructions. Further, the modules can be implemented by one or more hardware components, by computer-readable instructions executed by a processing unit, or by a combination thereof.

Furthermore, one or more computer-readable storage media may be utilized in implementing some of the embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It is intended that the disclosure and examples be considered as exemplary only, with a true scope of disclosed embodiments being indicated by the following claims.

We claim:

1. A method for generating a contextual narrative of one or more visualizations, the method comprising:
providing an input feed to a processor;
processing the input feed based on a set of predefined business rules, wherein the method of generating the contextual narrative further comprises,
generating a narrative of a visualization based on the processed input feed, wherein a context is provided to the generated narrative based on a plurality of semantic relationships established in an ontology file obtained from the input feed and at least one search criterion including, but not limited to, one or more filters and one or more aggregation types.

2. The method as claimed in claim 1, wherein the input feed comprises a visualization data file and a computational data file.

3. The method as claimed in claim 2, wherein the visualization data file is processed to identify one or more details regarding visualizations including, but not limited to, a dimension, a measure unit, a filter and a type of visual analytic.

4. The method as claimed in claim 2, wherein the computational data file is processed to compute one or more additional estimated values in range of the one or more values of the visualization data file.

5. The method as claimed in claim 1, wherein the set of predefined business rules are configured based on a user type, a data type in a visualization data file and a preliminary set of questions provided by one or more users.

6. The method as claimed in claim 2, wherein the visualization data file comprises a set of data required to prepare one or more visuals for one or more questions provided by one or more users.

7. The method as claimed in claim 2, wherein the computational data file includes, but not limited to, a set of data required to compute one or more additional estimated values and one or more business metric models for computing required business metrics such as growth rate, etc. as per plurality of questions provided by one or more users.

8. The method as claimed in claim 1, wherein the ontology file includes, but not limited to, a category of one or more attributes, one or more semantic relationships between the one or more attributes present within a dataset.

9. The method as claimed in claim 1, wherein the ontology file comprises a template and a plurality of business logic details regarding each value, measure unit, dimensions and data present in computational data file.

10. A system for generating a contextual narrative of one or more visualization, the system comprising:
a data input module, wherein the data input module provides an input feed;
a processor for processing the input feed based on a set of predefined business rules; and
wherein the system for generating the contextual narrative further comprises,
a narrative generator module for generating a narrative of a visualization based on the processed input feed, wherein a context is provided to the generated narrative based on a plurality of semantic relationships established in an ontology file obtained from the input feed and at least one search criteria including, but not limited to, one or more filters and one or more aggregation types.

11. The system as claimed in claim 10, wherein the input feed of the data input module comprises a visualization data file and a computational data file.

12. The system as claimed in claim 11, wherein the visualization data file is processed to identify one or more details regarding visualizations including, but not limited to, a dimension, a measure unit, a filter and a type of visual analytics.

13. The system as claimed in claim 11, wherein the computational data file is processed to compute one or more additional estimated values in range of one or more values of the visualization data file.

14. The system as claimed in claim 10, wherein the set of predefined business rules are configured based on a user type, a data type in a visualization data file and a preliminary set of questions provided by one or more users.

15. The system as claimed in claim 11, wherein the visualization data file comprise data required to prepare one or more visuals for one or more user questions provided by one or more users.

16. The system as claimed in claim 11, wherein the computational data file includes, but not limited to, set of data required to compute one or more additional estimated values and one or more business metric models for computing required business metrics such as growth rate, etc. as per plurality of questions provided by one or more users.

17. The system as claimed in claim 10, wherein the ontology file includes, but not limited to, a category of attributes, one or more semantic relationships between one or more attributes present within a dataset.

18. The method as claimed in claim 10, wherein the ontology file comprises a template and a plurality of business logic details regarding each value, measure unit and dimensions and data present in computational data file.

19. The system as claimed in claim 10, wherein the narrative generator module generates narratives based on the processed input feed using a narrative generator template and a deep learning paraphrasing model.

20. The system as claimed in claim 10, wherein the processor processes data present in a visualization data file and a computational data file.
